(19) United States
(12) Patent Application Publication
(10) Pub. No.: US 2021/0209620 A1
(43) Pub. Date: Jul. 8, 2021

(54) Assessing Impact of Media Data Upon Brand Worth

(71) Applicant: SAP SE, Walldorf (DE)

(72) Inventors: Rajesh Selvanayagam, Chennai (IN); Sumit Dey, Bangalore (IN); Mohammad Nabeel Siddiqui, Allahabad (IN)

(21) Appl. No.: 16/736,684

(22) Filed: Jan. 7, 2020

(51) Int. Cl. G06Q 30/02; G06F 16/951; G06N 20/00

(52) U.S. Cl. CPC G06Q 30/0201; G06Q 50/01; G06N 20/00; G06F 16/951

(57) ABSTRACT

Embodiments allow rapid prediction of the impact of media data upon brand worth. One cloud service crawls service providers (e.g., TWITTER, FACEBOOK, blogging services) and provides sentiment analysis of internet feeds. Another cloud service may have pre-populated knowledge of an internal organization chart, in order to focus upon feeds relating to employees. Yet another machine learning (ML) service may predict an impact of the media data upon brand worth. Data models of the ML service can consider factors such as: a source of the information, a particular publisher sharing the news, a time since the news was published, and/or a specific individual associated with the news. An output identifier could be a severity index, the sentiment (e.g., positive or negative), financial impact trends, the time to react, and others. Following testing of the data model and the training data, embodiments may predict the impact of a future media communication.

### BACKGROUND

Unless otherwise indicated herein, the approaches described in this section are not prior art to the claims in this application and are not admitted to be prior art by inclusion in this section.

An abundance of information is available on the internet. However, artificial information can be readily disseminated without any independent verification of its accuracy. Such manufactured information can have a serious negative impact upon the value of the brand of an organization or of an individual.

### SUMMARY

Cloud capabilities are leveraged in conjunction with Machine Learning (ML) to rapidly identify and predict the impact (financial or otherwise) of media data available on public forums. One cloud service may crawl service providers (e.g., TWITTER, FACEBOOK, blogging services) and provide sentiment analysis of internet feeds. Another cloud service may have pre-populated knowledge of an internal organization chart, in order to focus upon feeds relating to employees. Yet another machine learning (ML) service may predict an impact of the media data upon brand worth. Various data models of a ML service can consider factors such as: a source of the information, a particular publisher sharing the news, a time since the news was published, and/or a specific individual associated with the news. An output identifier could be a severity index, the sentiment (e.g., positive or negative), financial impact trends, the time to react, and others. Training data could be specific to a particular organization.

Following testing of the data model and the training data, embodiments may predict the impact of a future media communication. Embodiments may also be used as a channel for formally releasing notification of mergers, acquisitions, and/or other organizational announcements for external consumption.

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 2 shows a simplified flow diagram of a method according to an embodiment.

FIG. 3 shows a simplified view of a system architecture according to an example.

FIGS. 4A-4B lists a highly simplified sample of training data for machine learning according to the example.

FIG. 5 shows a simplified dashboard interface according to the example listing news or articles.

FIG. 6 shows a simplified dashboard interface according to the example showing an overview page.

FIG. 7 illustrates hardware of a special purpose computing machine according to an embodiment that is configured to assess an impact of media data upon brand worth.

FIG. 8 illustrates an example computer system.

FIG. 9 plots stock price and sentiment score over time.

### DETAILED DESCRIPTION

Described herein are methods and apparatuses assessing impact of media data upon brand worth. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

As noted above, with the rise of the internet, the intentional circulation of false information can have serious business consequences. However, it can be difficult to track and control the spread of false information regarding an organization or an individual.

Accordingly embodiments seek to discover artificial information regarding an entity (organization or individual) its representatives, that has been communicated on the internet at any given point in time. Embodiments may also predict the financial impact of the dissemination of such information.

Embodiments may also assess the impact upon brand worth of data other than manufactured internet communications. Examples of such data can include but are not limited to:

confidential mails leaked to the public,

revenue information published before planned dates, or

internal organizational announcements that are made public.

Accordingly embodiments leverage cloud capabilities in conjunction with machine learning, in order to rapidly identify and predict the impact (financial or otherwise) of media data that is available on public forums. One cloud service may crawl service providers (e.g., TWITTER, FACEBOOK, blogging services) and provide sentiment analysis of internet feeds. Another cloud service may have pre-populated knowledge of an internal organization chart, in order to focus upon feeds relating to employees. Yet another machine learning (ML) service may predict an impact of the media data upon brand worth. Various data models of a ML service can consider factors such as: a source of the information, a particular publisher sharing the news, a time since the news was published, and/or a specific individual associated with the news. An output identifier could be a severity index, the sentiment (e.g., positive or negative), financial impact trends, the time to react, and others. Training data could be specific to a particular organization.

Overall, embodiments can identify that some news related to the organization is receiving more attention than usual. That news will be listed in a portal for an administrator, together with a prediction of the impact of the news using the ML service. Based upon the prediction, the organization can rapidly and effectively respond to news being shared on the internet.

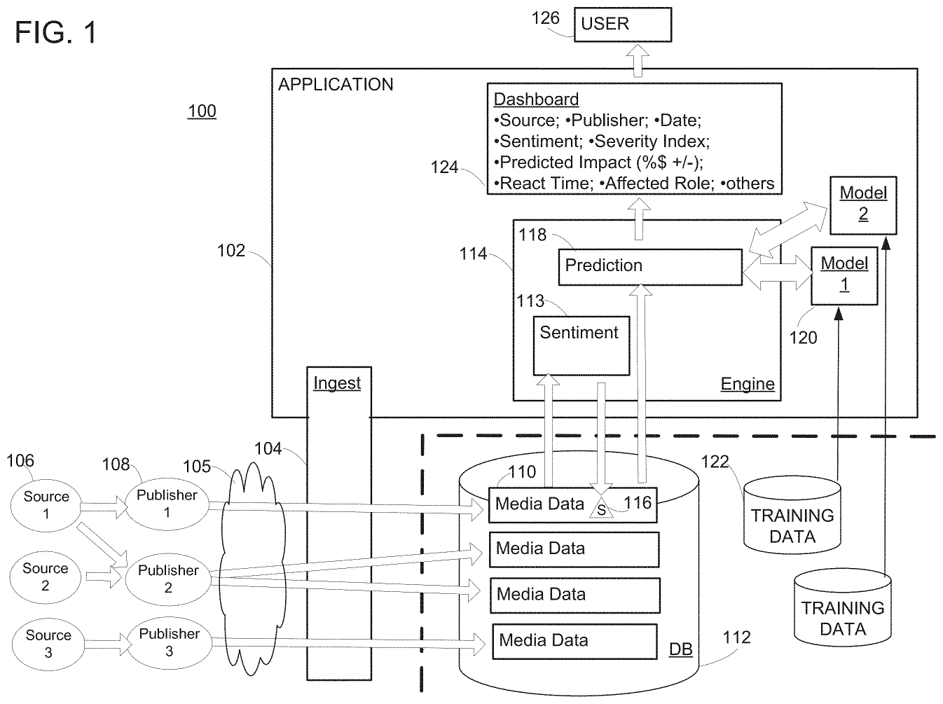

FIG. 1 shows a simplified view of an example system that is configured to provide impact assessment according to an embodiment. Specifically, system 100 comprises an application 102 comprising an ingestion element 104.

The ingestion element is configured to receive media information over a network (e.g., the internet 105) from a plurality of sources 106, as may be published from one or more social media platforms 108. As shown, information from a single source may be available over multiple social media platforms.

The ingestion component of the application forwards the incoming social media data 110 for persistence within a database 112.

Next, a sentiment component 113 the engine 114 assigns a sentiment 116 to the media data. This assigned sentiment may be the result of semantic analysis of the content of the media data (e.g., using keywords).

Then, a prediction component 118 of the engine generates a prediction of the impact of the media data upon a value of a brand. In particular, the engine references a model 120 that describes a predicted relationship between various types of information. The model is developed utilizing a corpus of historical training data 122, that accurately reflects past actual correlation between the constituent elements of the model.

FIG. 1 shows that a plurality of models may be available. The reference to a particular model may depend upon the form of the media information. For example, a first model could be referenced where the media information is in unstructured form. A different model could be referenced where the media information is in structured form, and still another model could be referenced where the media information is in numerical form.

Such information contained within the model and reflected by the training data, can include but is not limited to:

source of the media data;

publisher of the media data;

time since publication of the media data;

keyword(s) of the media data;

internal employee role affected by the media data;

sentiment output identifier;

finance data;

organizational data of the affected entity;

a predicted trending severity index.

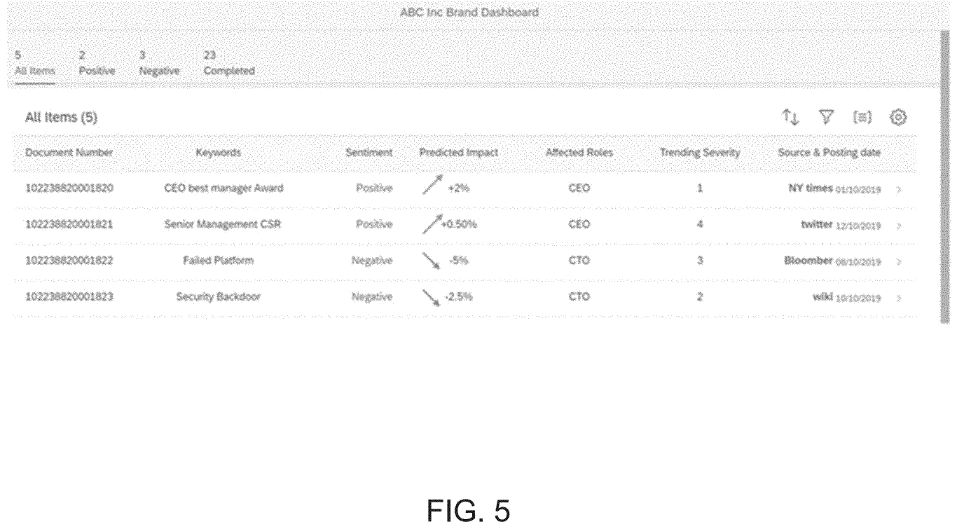

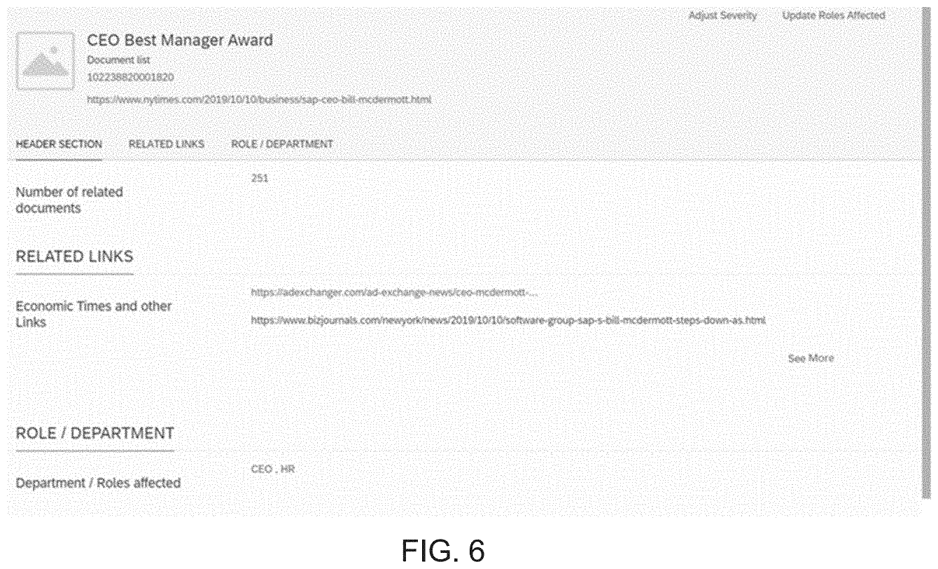

The results of modeling the collected media data (and values derived therefrom such as sentiment and response time), is output to the dashboard 124. There, the user 126 (who may comprise a portal end user or an administrator user as detailed below), can review and assess the predicted impact of the collected media data upon an entity's brand value. Exemplary screens of a dashboard interface are described later below in connection with FIGS. 5 and 6.

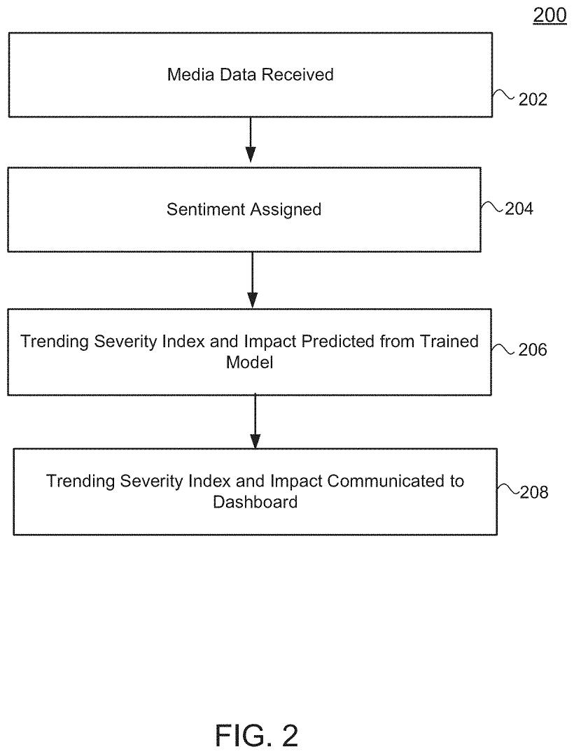

FIG. 2 is a flow diagram showing various actions taken in a method 200 according to an embodiment. At 202, published media data is received from source.

At 204, a sentiment is assigned to the media data. At 206, the media data is input to a model to generate a predicted trending severity index and an impact value.

At 208, the predicted trending severity index and the impact value are communicated to a dashboard.

Embodiments may offer certain benefits over conventional approaches. For example, certain embodiments may better determine a media platform upon which to market a particular product or service.

That is, embodiments may allow identification of a most desired media platform for the product's market, and/or obtaining the desired information to provide a maximum financial advantage. For example, during the initial growth stages of a brand or an organization, it is important to generate more investments. In order to promote such early investment, positive news should be available on the internet.

Moreover, embodiments may allow filtering for the communications which are having a negative impact. That is, embodiments allow for predicting in advance, a financial impact of any circulated news.

Accordingly, prior to making any public announcements, a user can predict the impact of that news on the brand. Based upon the prediction, aspects of the announcement (e.g., timing, channel, tone) can be carefully controlled in order to reduce any potentially negative impact.

In addition, embodiments may afford prediction of a best time to react to media data circulated on the internet. That is, a list of online articles or feeds is initially provided to a number of users.

Before a news story goes viral, embodiments can predict the impact and clarify if some incorrect information is about to shared. Embodiments thus permit an entity to intelligently track and act on information shared online that could affect a brand's value.

Further details are now provided in connection with a particular example involving specific elements available from SAP SE, of Walldorf, Germany.

### Example

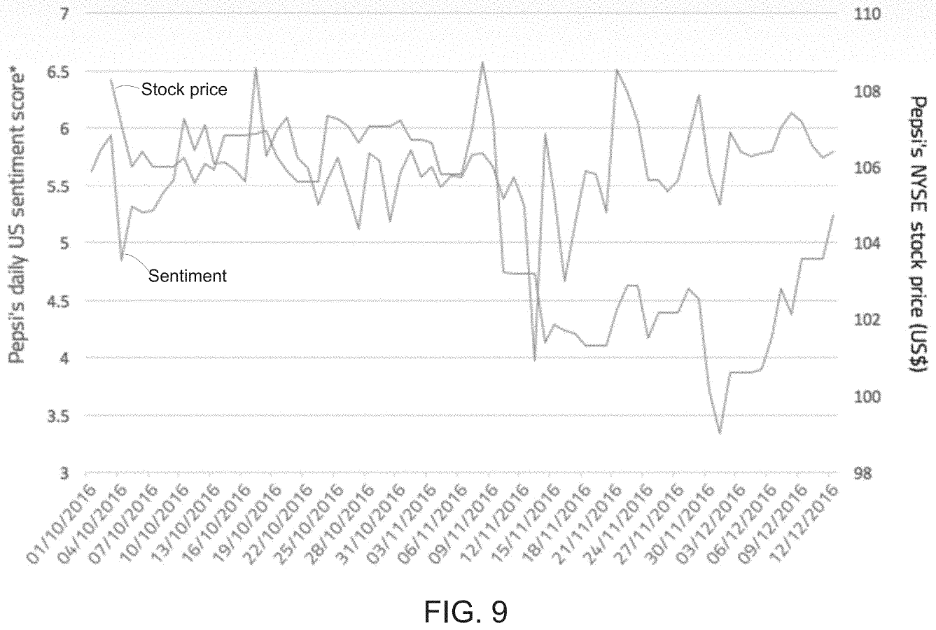

In November of 2016, the president of PepSi Co, Inc. was incorrectly quoted by certain social media outlets as stating that supporters of President Donald Trump should take their business elsewhere. FIG. 9 plots the corresponding stock price and sentiment score over time for this event.

Specifically, in the weeks preceding the incident, the stock price averaged around $106.58. On Nov. 10, 2016, the news began to circulate, and the stock dropped in value. Over the following weekend, the story continued to be prominent, and the share value trended lower when the markets opened on Nov. 14, 2016.

This (and other) historical data can provide valuable insight to predict the potential impact of media publication upon brand worth. In particular, embodiments offer the ability to detect and mitigate the impact of such potentially harmful media publication events.

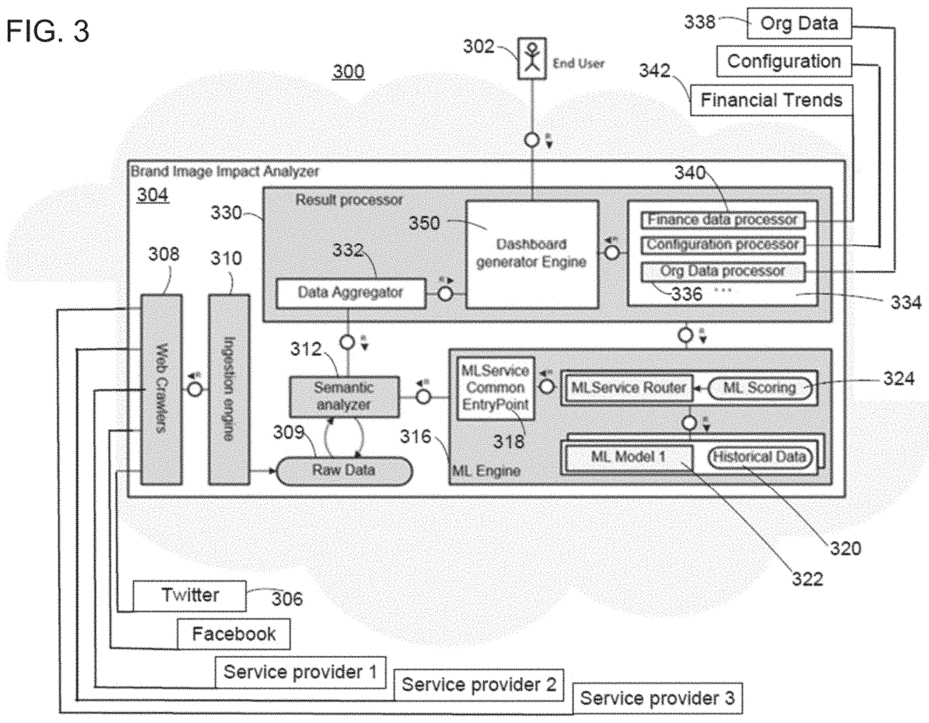

FIG. 3 shows a simplified view of a specific system architecture 300 according to an example. User 302 is in communication with Brand Image Impact Analyzer 304. As discussed in detail below, the user may comprise a portal user or an administrative user.

The analyzer is in communication with various media sources 306. These can include TWITTER, FACEBOOK, and service providers. Web Crawlers 308 harvest raw data 309 from those sources on a regular basis, and communicate that information to ingestion engine 310.

A semantic analyzer 312 processes the raw data for relevancy to an entity. The entity-relevant data is communicated to a machine learning engine 316 via an entry point 318. The machine learning entry references historical data 320 according to a model 322, allowing the machine learning engine to perform severity scoring 324.

It is noted that a number of different models may be available for reference, depending upon factors that may include the form of the stored media information. For example, a first model could be referenced for structured media information, a second model could be referenced for unstructured media information, and a third model could be referenced for media information that is exclusively numerical.

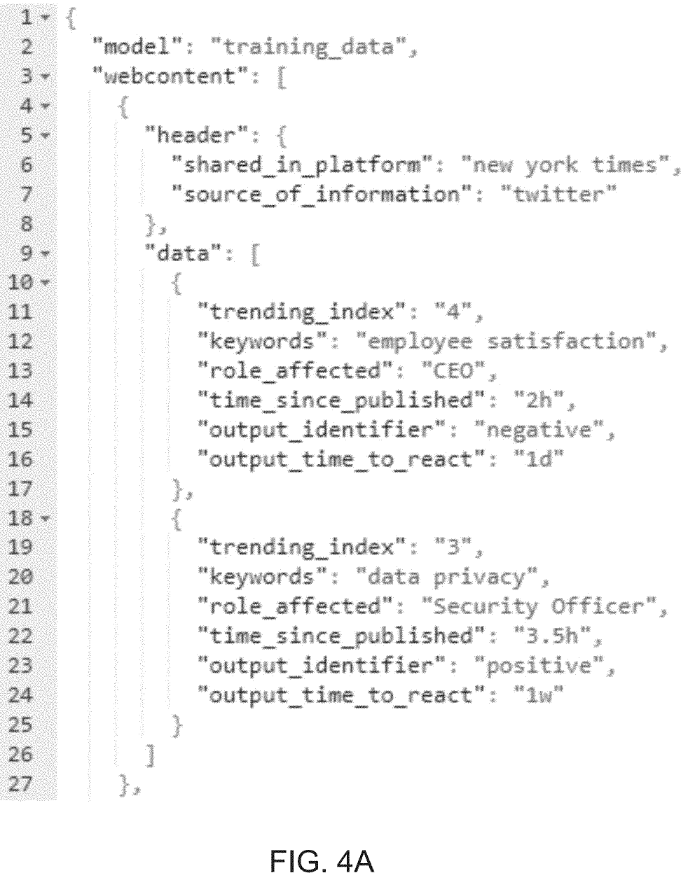

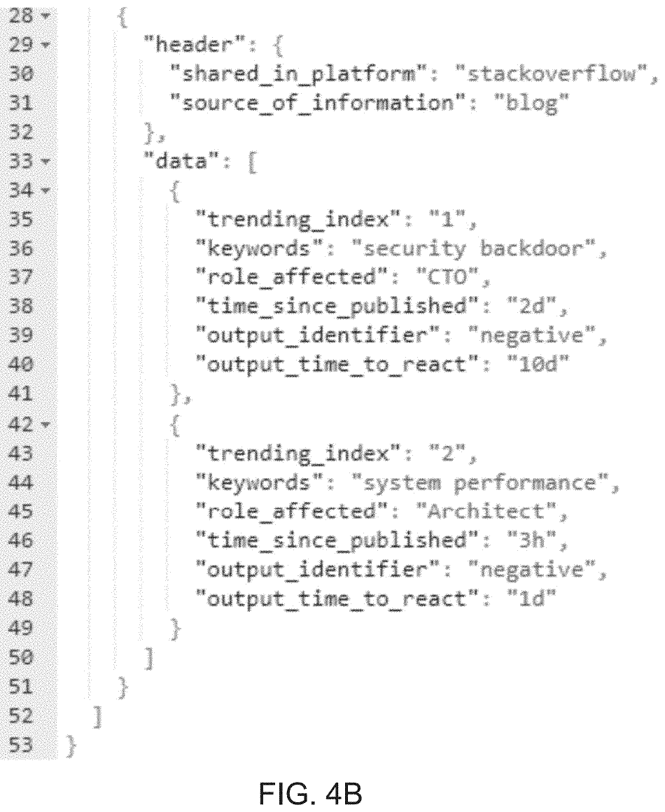

FIGS. 4A-4B lists sample training data for machine learning according to the example. The training data shown here is highly simplified for purposes of explanation. In practical implementation, the training data may in fact include a number of additional fields.

For this simplified sample, the training data of FIGS. 4A-B includes fields for:

publication platform;

data source;

severity index;

keywords;

role affected;

time since publication;

sentiment output identifier; and

output time to react.

The result processor 330 is in communication with, and receives inputs from, each of the following:

the machine learning engine;

the semantic analyzer (via data aggregator 332); and

various processors 334.

In particular, an organization data processor 336 is in communication with organization data 338 (e.g., such as an organization chart) providing details regarding the internal structure of the entity whose brand value is being monitored. This can be valuable in identifying the internal role within the entity having relevance of published media items, for example to identify a potential source of internal data (i.e., leaker).

A finance data processor 340 is in communication with stored financial trend information 342. Those financial trends may include, for example the current stock price and legacy stock price of the entity.

Returning to FIG. 3, the user 302 is in communication with a dashboard generator engine 350 to receive results of the impact assessment. Users of at least two different types, are possible.

A portal end user can include individuals or teams responsible for Public Relations (PR), marketing, or managing Human Resources (HR) functions. These are individuals serving in roles calling for an understanding of the value of a brand on the internet.

A portal end user may seek a variety of different types of outputs from the system. For example, an end user may want to get a list of all the news or articles discussed on a particular brand or organization, in order to understand public reaction.

A portal end user may seek to obtain a list of news or articles in order of severity, in order to focus upon the most important ones. For simplified review, an end user may desire the option to link or to merge multiple articles into a same bucket, in order to avoid having to individually review many articles on similar topics. FIG. 5 shows a simplified page of a dashboard interface according to the example, listing news or articles by severity.

A portal end user may want to be able to adjust a severity of the news or article, in order to allow it to be used for future articles along similar lines. FIG. 6 shows a simplified dashboard interface according to the example including an overview page.

An end user may want to be able to add/remove certain publishing platforms or information sources, that could also influence a brand's value. For example, embodiments may offer the possibility of an organization adding the TWITTER accounts of its own senior management to a list of monitored media streams.

A different type of possible user for the impact assessment system is an administrator user. This type of user seeks to operate and maintain the software environment affording impact assessment.

An administrator user may be able to add/remove the sources or publisher from which the software obtains media news or articles. An administrator user may also be able to monitor the veracity and/or the predicted severity, in order to become familiar with the accuracy of the software.

An administrator end user may be concerned with issues such as:

authentication;

security;

software health monitoring; and/or

retraining the data model.

Returning to FIG. 1, there the particular embodiment is depicted with the engine responsible for providing impact assessment, as being located outside of the database storing the media data. However, this is not required.

Rather, alternative embodiments could leverage the processing power of an in-memory database engine (e.g., the in-memory database engine of the HANA in-memory database available from SAP SE), in order to perform various functions.

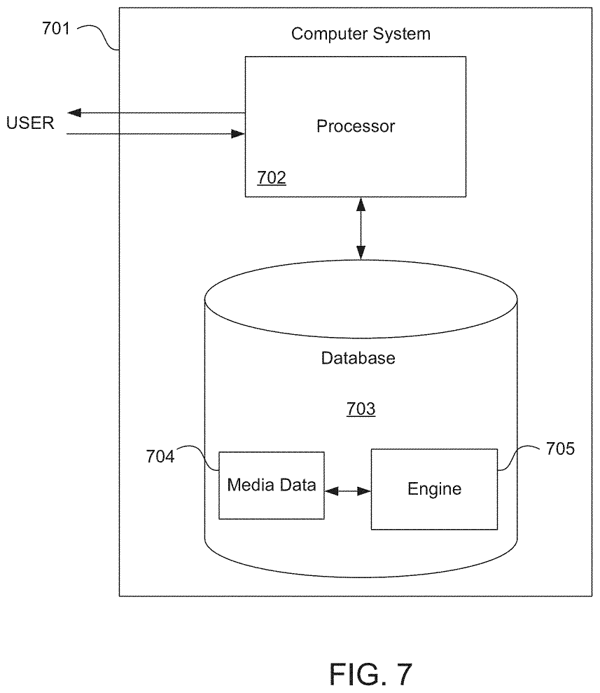

Thus FIG. 7 illustrates hardware of a special purpose computing machine configured to perform media impact assessment according to an embodiment. In particular, computer system 701 comprises a processor 702 that is in electronic communication with a non-transitory computer-readable storage medium comprising a database 703. This computer-readable storage medium has stored thereon code 705 corresponding to an engine. Code 704 corresponds to media data. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

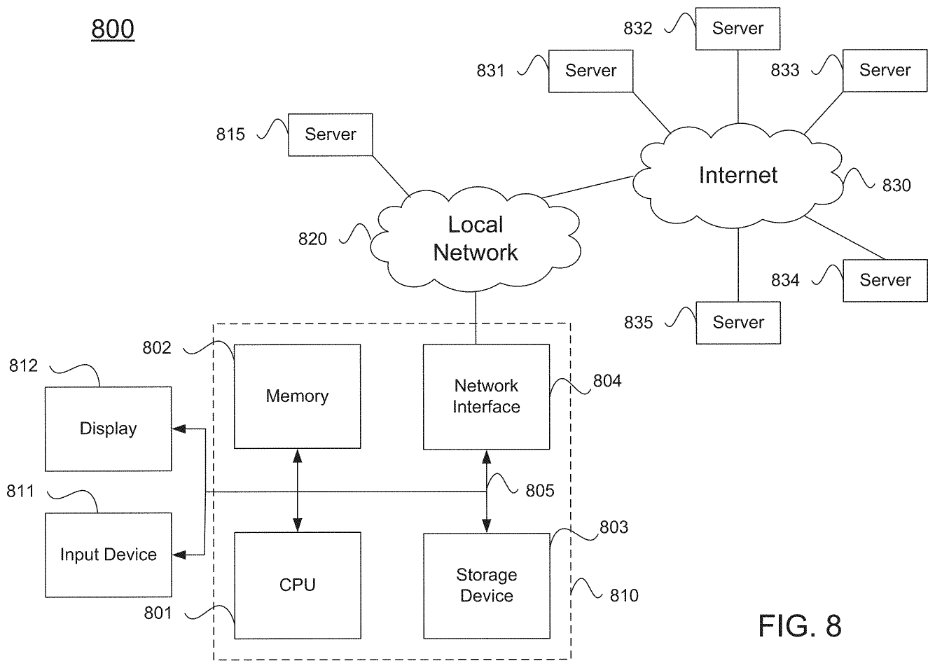

An example computer system 800 is illustrated in FIG. 8. Computer system 810 includes a bus 805 or other communication mechanism for communicating information, and a processor 801 coupled with bus 805 for processing information. Computer system 810 also includes a memory 802 coupled to bus 805 for storing information and instructions to be executed by processor 801, including information and instructions for performing the techniques described above, for example. This memory may also be used for storing variables or other intermediate information during execution of instructions to be executed by processor 801. Possible implementations of this memory may be, but are not limited to, random access memory (RAM), read only memory (ROM), or both. A storage device 803 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 803 may include source code, binary code, or software files for performing the techniques above, for example. Storage device and memory are both examples of computer readable mediums.

Computer system 810 may be coupled via bus 805 to a display 812, such as a cathode ray tube (CRT) or liquid crystal display (LCD), for displaying information to a computer user. An input device 811 such as a keyboard and/or mouse is coupled to bus 805 for communicating information and command selections from the user to processor 801. The combination of these components allows the user to communicate with the system. In some systems, bus 805 may be divided into multiple specialized buses.

Computer system 810 also includes a network interface 804 coupled with bus 805. Network interface 804 may provide two-way data communication between computer system 810 and the local network 820. The network interface 504 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 804 sends and receives electrical, electromagnetic, or optical signals that carry digital data streams representing various types of information.

Computer system 810 can send and receive information, including messages or other interface actions, through the network interface 804 across a local network 820, an Intranet, or the Internet 830. For a local network, computer system 810 may communicate with a plurality of other computer machines, such as server 815. Accordingly, computer system 810 and server computer systems represented by server 815 may form a cloud computing network, which may be programmed with processes described herein. In the Internet example, software components or services may reside on multiple different computer systems 810 or servers 831-835 across the network. The processes described above may be implemented on one or more servers, for example. A server 831 may transmit actions or messages from one component, through Internet 830, local network 820, and network interface 804 to a component on computer system 810. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
receiving from a source, media data relevant to an entity;
performing semantic analysis of the media data to determine a sentiment;
storing the sentiment with the media data in a database;
referencing a model based upon the media data and the sentiment to generate an output comprising a severity index and an impact value upon a brand of the entity; and
communicating the output to a dashboard.

2. A method as in claim 1 further comprising referencing financial data to generate the impact value.

3. A method as in claim 1 wherein:
the output further comprises a role affected by the media data; and
the method further comprises referencing organizational data of the entity to generate the role.

4. A method as in claim 3 wherein:
the media data comprises leaked information of the entity; and
the role comprises a leaker of the leaked information.

5. A method as in claim 1 wherein the media data is received from a web crawler.

6. A method as in claim 1 further comprising creating the model from a corpus of training data.

7. A method as in claim 6 further comprising:
the dashboard receiving an adjustment of the severity index;
adding the adjustment to the training data; and
updating the model using the training data including the adjustment.

8. A method as in claim 1 wherein:
the database comprises an in-memory database; and
referencing the model is performed by an in-memory database engine of the in-memory database.

9. A non-transitory computer readable storage medium embodying a computer program for performing a method, said method comprising:
receiving from a source, media data relevant to an entity;
performing semantic analysis of the media data to determine a sentiment;
storing the sentiment with the media data in a database;
referencing a model and organizational data of the entity based upon the media data and the sentiment, to generate an output comprising a severity index, an impact value upon a brand of the entity, and a role affected by the media data; and
communicating the output to a dashboard.

10. A non-transitory computer readable storage medium as in claim 9 wherein:
the media data comprises leaked information of the entity; and
the role comprises a leaker of the leaked information.

11. A non-transitory computer readable storage medium as in claim 9 wherein the method further comprises referencing financial data to generate the impact value.

12. A non-transitory computer readable storage medium as in claim 9 wherein the method further comprises creating the model from a corpus of training data.

13. A non-transitory computer readable storage medium as in claim 12 wherein the method further comprises:
the dashboard receiving an adjustment of the severity index;
adding the adjustment to the training data; and
updating the model using the training data including the adjustment.

14. A non-transitory computer readable storage medium as in claim 9 wherein:
the database comprises an in-memory database; and
referencing the model is performed by an in-memory database engine of the in-memory database.

15. A computer system comprising:
one or more processors;
a software program, executable on said computer system, the software program configured to cause an in-memory database engine of an in-memory database to:
receive from a source, media data relevant to an entity;
perform semantic analysis of the media data to determine a sentiment;
store the sentiment with the media data in the in-memory database;
reference a model based upon the media data and the sentiment to generate an output comprising a severity index and an impact value upon a brand of the entity; and
communicate the output to a dashboard.

16. A computer system as in claim 15 wherein the in-memory database engine is further configured to reference financial data to generate the impact value.

17. A computer system as in claim 15 wherein:
the output further comprises a role affected by the media data; and
the in-memory database engine is further configured to referencing organizational data of the entity to generate the role.

18. A computer system as in claim 15 wherein the model is created from a corpus of training data, and the in-memory database engine is further configured to:
receive from the dashboard an adjustment of the severity index;
add the adjustment to the training data; and
update the model using the training data including the adjustment.

19. A computer system as in claim 15 wherein the media data is received from a web crawler.

20. A computer system as in claim 15 wherein the output further comprises a time to react.
